(19) United States
(12) Patent Application Publication
(10) Pub. No.: US 2023/0103964 A1
(43) Pub. Date: Apr. 6, 2023

(54) WELDING CONNECTION ELEMENT

(71) Applicant: DTECH PRECISION INDUSTRIES CO., LTD., NEW TAIPEI CITY (TW)

(72) Inventor: TING-JUI WANG, NEW TAIPEI CITY (TW)

(21) Appl. No.: 18/079,935

(22) Filed: Dec. 13, 2022

Related U.S. Application Data
(63) Continuation of application No. 16/876,521, filed on May 18, 2020.
Application No. 16/876,521 is a continuation-in-part of application No. 16/740,632, filed on Jan. 13, 2020.
Application No. 16/740,632 is a continuation-in-part of application No. 15/132,357, filed on Apr. 19, 2016, now abandoned.

(51) Int. Cl. B23K 3/08; B23K 1/00; F16B 21/08

(52) U.S. Cl. CPC B23K 3/087; B23K 1/0016; F16B 21/086; B23K 2103/12

(57) ABSTRACT

A welding connection element includes a body and an assembly portion. The body includes a fitting fastening portion having an elastic withdrawal space. The elastic withdrawal space is capable of elastically withdrawing two or more fastening portions, so as to enable the fastening portions to be receivingly fastened in another object. The welding connection element has a welding surface configured to be welding connected to a welding surface of the object. The welding surface of the object is provided in advance with a solder layer configured to be heated and to welding connect the welding connection element and the welding surface of the object. The welding connection element is provided at a carrier in advance, taken out by a tool, compared with an assembly position of the object by a comparison device, and placed at the assembly position by the tool so as to be assembled with the object.

### CROSS-REFERENCE TO RELATED APPLICATION

This application is a continuation application of U.S. application Ser. No. 16/876,521 filed on May 18, 2020, which is a CIP of U.S. Ser. No. 16/740,632, filed on Jan. 13, 2020, which is a CIP of U.S. Ser. No. 15/132,357, filed on Apr. 19, 2016, the entire contents of which are hereby incorporated by reference for which priority is claimed under 35 U.S.C. § 120.

### BACKGROUND OF THE INVENTION

### 1. Field of the Invention

The present invention relates to a welding connection element, and more particularly to a welding connection element capable of completing fastening connection and unfastening of at least two objects, achieving repeated quick fastening connection and unfastening.

### 2. Description of the Related Art

To couple at least one object, lock connection is usually performed using a screw so as to couple the object.

However, although being capable of coupling at least one object into a form that is not easily separated, the conventional fixing means above may result in a complicated disassembly process after the assembly.

### BRIEF SUMMARY OF THE INVENTION

In view of the issues and drawbacks of the prior art, the inventor has dedicated to research and development of a welding connection element so as to complete fastening connection and unfastening of at least two objects, achieving the object of repeated quick fastening connection and unfastening.

To achieve the above and other objects, the present invention provides a welding connection element including a body and an assembly portion. The body includes a fitting fastening portion. Further, the welding connection element has a welding surface configured to be welding connected and assembled to an object.

The present invention further provides a welding connection element including a body and an assembly portion. The body includes a fitting fastening portion. The welding connection element is configured to be arranged at a carrier, picked up by a tool, compared with an assembly position of an object by a comparison device, and placed at the assembly position by the tool so as to be assembled to the object.

The present invention further provides a welding connection element including a body and an assembly portion. The assembly portion is for assembling to an object. The body includes a fitting fastening portion having an elastic withdrawal space. The elastic withdrawal space is capable of elastically withdrawing two or more fastening portions, so as to enable the fastening portions to be receivingly fastened in another object.

The present invention further provides a welding connection element including a body, an assembly portion and a fitting fastening portion. The welding connection element has a welding surface configured to be welded to a welding surface of an object. The welding surface of the object is provided in advance with a solder layer configured to be heated and to welding connect the welding connection element and the welding surface of the object.

The present invention further provides a welding connection element including a body, an assembly portion and a fitting fastening portion. The welding connection element has a welding surface configured to be welding connected to a welding surface of an object. The welding surface of the object is provided in advance with a solder layer configured to be heated and to welding connect the welding connection element and the welding surface of the object. A non-welding surface of the object is under the welding surface of the object.

The present invention further provides a welding connection element including a body, an assembly portion and a fitting fastening portion. The welding connection element has a welding surface configured to be welding connected to a welding surface of an object. The welding surface of the object is provided in advance with a solder layer configured to be heated and to welding connect the welding connection element and the welding surface of the object. The welding connection element is provided in advance at a carrier, taken out by a tool, compared with an assembly position of the object by a comparison device, and placed at the assembly position by the tool, so as to be assembled to the object.

The present invention further provides a welding connection element including a body and an assembly portion. The assembly portion is configured to be assembled to an object. The body includes a fitting fastening portion having an elastic withdrawal space. The elastic withdrawal space is capable of withdrawing two or more fastening portions, so as to enable the fastening portions to be fittingly fastened in another object. The welding connection element has a welding surface configured to be welding connected to a welding surface of the object. The welding surface of the object is provided in advance with a solder layer configured to be heated and to welding connect the welding connection element and the welding surface of the object. The welding connection element is provided in advance at a carrier, taken out by a tool, compared with an assembly position of the object by a comparison device, and placed at an assembly position of the object by the tool, so as to be assembled to the object.

The present invention further provides a welding connection element including a body and an assembly portion. The assembly portion is for assembling to an object. The body includes a fitting fastening portion having an elastic withdrawal space. The elastic withdrawal space is capable of elastically withdrawing two or more fastening portions so as to enable the fastening portions to be receivingly fastened in another object. The welding connection element has a welding surface configured to be welding connected to a welding surface of the object. The welding surface of the object is provided in advance with a solder layer configured to be heated and to welding connect the welding connection element and the welding surface of the object.

The present invention further provides a welding connection element including a body and an assembly portion. The assembly portion is configured to be assembled to an object. The body includes a fitting fastening portion having an elastic withdrawal space. The elastic withdrawal space is capable of elastically withdrawing two or more fastening portions so as to enable the fastening portions to be receivingly fastened in another object. The welding connection element is provided in advance at a carrier, taken out by a tool, compared with an assembly position of the object by a comparison device, and placed at the assembly position by the tool, so as to be assembled to the object.

The present invention further provides a welding connection element including a body and an assembly portion. The assembly portion is for assembling to an object. The body includes a fitting fastening portion, which has an elastic withdrawal space configured to enable the fastening portion to be receivingly fastened in another object. The welding connecting portion is provided in advance at a carrier, taken out by a tool, compared with an assembly position of the object by a comparison device, and placed at the assembly position by the tool, so as to be assembled to the object.

The present invention further provides a welding connection element including a body and an assembly portion. The assembly portion is configured to be assembled to an object. The body includes a fitting fastening portion, which has an elastic withdrawal space configured to enable to the fastening portion to be receivingly fastening in another object. The welding connection element has a welding surface configured to be welding connected to a welding surface of the object. The welding surface of the object is provided in advance with a solder layer configured to be heated and to welding connect the welding connection element and the welding surface of the object.

In the foregoing welding connection element, a support portion is provided below the fastening portion of the body, and is configured to fittingly engage another object receivingly fastened.

In the foregoing welding connection element, the assembly portion includes a shoulder, which is capable of supporting an assembled portion of the object.

The foregoing welding connection element is assembled to an assembled portion of the object. The assembled portion is an insertion portion, a recess, a protrusion, a slot, a hole or a planar surface portion.

In the foregoing welding connection element, the welding surface of the object is arranged on a planar surface, on a surface, in an insertion portion or on a surface of an insertion portion of the object.

In the foregoing welding connection element, the fitting fastening portion includes two or more fastening portions, between which an elastic withdrawal space is present. The elastic withdrawal space is capable of elastically withdrawing to enable the fastening portions to be receivingly fastening in another object.

In the foregoing welding connection element, the welding surface of the welding connection element is provided at the assembly portion, and is configured to be heated and welding connected to the welding surface of the object.

In the foregoing welding connection element, the welding surface of the welding connection element is provided at the assembly portion. The welding surface of the object is provided in advance with a solder layer configured to be heated and to weld connect the welding connection element and the welding surface of the object.

The foregoing welding connection element is provided in advance at a carrier, which includes a cover. The cover is opened, and the welding connection element is picked up and placed at the object by the tool for welding connection.

In the foregoing welding connection element, the welding connection element is provided in advance at a carrier, taken out by a tool, compared with an assembly position of the object by a comparison device, and placed at the assembly portion by the tool, so as to be assembled to the object.

In the foregoing welding connection element, the welding surface of the welding connection element, or the welding surface of the object configured for assembly and welding connection, is a copper layer, a tin layer or a nickel layer.

The foregoing welding connection element is picked up by a tool from a carrier provided in advance, compared with an assembly position of the object by a comparison device, and placed at the assembly position by the tool, so as to be assembled with the object. The tool is a vacuum suction tool, fastener, a fixture or a magnetic tool.

The foregoing welding connection element is picked up by a tool from a carrier provided in advance, and compared and placed at an assembly position by a comparison tool. The comparison tool is a visual comparison device, an image comparison device, a distance comparison device or a computer comparison device.

In the foregoing welding connection element, the fitting fastening portion includes two or more fastening portions, between which an elastic withdrawal space is present. Each of the fastening portions has a guiding surface configured to enable the elastic withdrawal space to elastically withdraw while guiding another object to be receivingly fastened.

In the foregoing welding connection element, the fitting fastening portion is a thread body, a protrusion fastener, a column body, an inner fastener or an outer fastener.

The foregoing welding connection element is provided with an intermediate body. The welding connection element is picked up by a tool via the intermediate body, compared with an assembly position of the welding connection element and the object, placed at the assembly position and welding connected to the object.

The foregoing welding connection element is provided with an intermediate body. The welding connection element is picked by a tool via the intermediate body and placed at the assembly position of the object for welding connection, and the intermediate body is then removed.

In the foregoing welding connection element, the intermediate body is a plate or a fastener.

In the foregoing welding connection element, a support portion is provided between the fastening connecting portion and the assembly portion. The support portion is configured to define the position for the assembly portion to be assembled to the object, and support the position of another object that is receivingly fastened in the fitting fastening portion.

In the foregoing welding connection element, the object is a printed circuit board.

The foregoing welding connection element is provided at a carrier, which is a feed belt or a feed tray.

The foregoing welding connection element is picked up at the assembly portion by the tool, and placed at the assembly position of the object.

In the foregoing welding connection element, the assembly portion has s width more than that of an assembled portion of the object, and the fitting fastening portion has a width less than that of the assembled portion of the object. The fitting fastening portion is first inserted in the assembled portion and then assembled to the object by the assembly portion.

In the foregoing welding connection element, a limiting portion of the body has a width less than that of an assembled portion of the object and more than that of the fitting fastening portion, and is configured to be inserted at the assembled portion so as to limit a space and a position corresponding to the assembled portion.

In the foregoing welding connection element, the body has an elastic element. The elastic element presses the fitting fastening portion vertically or horizontally to provide a reciprocal elastic force.

In the foregoing welding connection element, the fitting fastening portion is a fastener formed integrally with the body. Alternatively, the fitting fastener is a notch between the fastening portions and is an integrally formed with the body, the fitting fastening portion is a fastener assembled at the body, or the fitting fastener is a sphere assembled at the body.

In the foregoing welding connection element, the fitting fastening portion has an outer diameter corresponding to a fastening connected structure of another object, and is configured to be shrunken by applying interference from bottom-up or from top-down to being capable of passing through the fastening connected structure, and then restoringly expanded to being fastened to the fastening connected structure, so as to be fastening connected to the another object.

The foregoing welding connection element further includes a body and an assembly portion. The assembly portion is configured to be assembled to an object. The body includes a fitting fastening portion having an elastic withdrawal space. The elastic withdrawal space is capable of elastically withdrawing two or more fastening portions, so as to enable the fastening portions to be receivingly fastened in another object.

In the foregoing welding connection element, the fitting fastening portion has an outer diameter more than that of a fastening connected structure of another object, and is configured to be shrunken by horizontally applying interference to being capable of passing through the fastening connected structure, and then restoringly expanded to being fastened by the fastening connected structure to another object.

In the foregoing welding connection element, the fitting fastening portion has an outer diameter more than that of an opening portion of a fastening connected structure of another object to be fastened to, and is configured to be shrunken by horizontally applying interference to being capable of passing through the opening portion of the fastening connected structure, and then restoringly expanded to being fastened at a receivingly fastening portion larger than the opening portion of the fastening connected structure, so as to be fastening connected to another object.

Thus, the welding connection element of the present invention is capable of fastening connecting or unfastening to complete fastening connection or unfastening of at least two object, achieving the object of repeated quick fastening connection or unfastening.

### BRIEF DESCRIPTION OF THE DRAWINGS

FIG. 1 is a schematic diagram of a side view state according to a first preferred embodiment of the present invention.

FIG. 2 is a schematic diagram of a side view state according to a second preferred embodiment of the present invention.

FIG. 3 is a schematic diagram of a side view state according to a third preferred embodiment of the present invention.

FIG. 4 is a schematic diagram of a side view state according to a fourth preferred embodiment of the present invention.

FIG. 5 is a schematic diagram of a side view state according to a fifth preferred embodiment of the present invention.

FIG. 6 is a schematic diagram of a side view state according to a sixth preferred embodiment of the present invention.

FIG. 7 is a schematic diagram of a side view state according to a seventh preferred embodiment of the present invention.

FIG. 8 is a first schematic diagram of a state of use of the present invention.

FIG. 9 is a second schematic diagram of a state of use of the present invention.

FIG. 10 is a third schematic diagram of a state of use of the present invention.

FIG. 11 is a schematic diagram of different forms of objects of the present invention.

FIG. 12 is a schematic diagram of different forms of a fitting fastening portion of the present invention.

FIG. 13 is a schematic diagram of different forms of a carrier of the present invention.

FIG. 14 is a fourth schematic diagram of a state of use of the present invention.

FIG. 15 is a fifth schematic diagram of a state of use of the present invention.

FIG. 16 is a sixth schematic diagram of a state of use of the present invention.

FIG. 17 is a seventh schematic diagram of a state of use of the present invention.

FIG. 18 is an eighth schematic diagram of a state of use of the present invention.

FIG. 19 is a schematic diagram of a side view state according to an eighth preferred embodiment of the present invention.

FIG. 20 is a schematic diagram of a side view state according to a ninth preferred embodiment of the present invention.

FIG. 21 is a first schematic diagram of a state of use according to a tenth preferred embodiment of the present invention.

FIG. 22 is a second schematic diagram of a state of use according to the tenth preferred embodiment of the present invention.

### DETAILED DESCRIPTION OF THE INVENTION

To fully understand the objects, features and functions of the present invention, details of the present invention are given in specific embodiments with the accompanying drawings under.

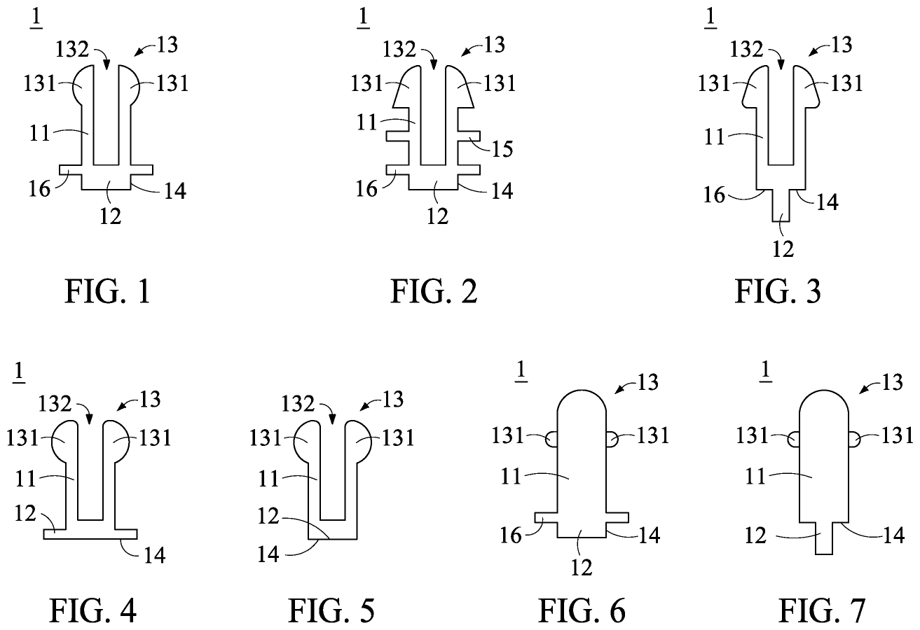

Referring to FIG. 1 to FIG. 3, as shown, the present invention provides a welding connection element 1 (as shown in FIG. 1 to FIG. 7) including a body 11 and an assembly portion 12. The body 11 includes a fitting fastening portion 13. The welding connection element 1 has a welding surface 14 configured to be welding connected and assembled to an object 2 (the object 2 may be a printed circuit board).

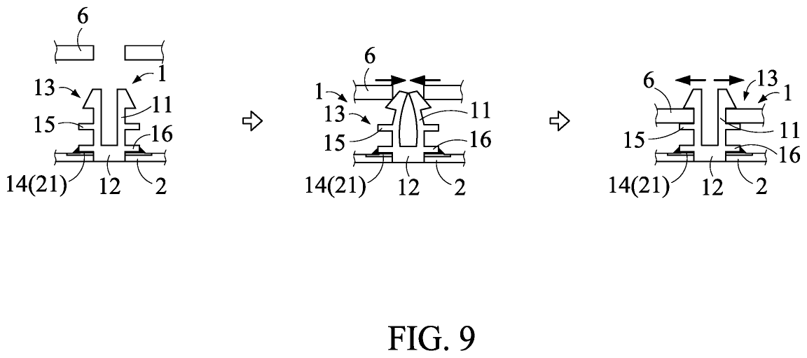

The fitting fastening portion 13 of the present invention has an elastic withdrawal space 132 (as shown in FIG. 1 to FIG. 5). The elastic withdrawal space 132 is capable of elastically withdrawing two or more fastening portions 131, so as to enable the fastening portions 131 to be receivingly fastened in another object 6 (as shown in FIG. 9).

Further, the fitting fastening portion 13 has an outer diameter more than that of a fastening connected structure of the another object 6, and is configured to be shrunken by applying interference from top-down or bottom-up to being capable of passing through the fastening connected structure, and to be restoringly expanded and fastened to the fastening connected structure, so as to enable the fastening portions 131 to be fastening connected to the another object 6.

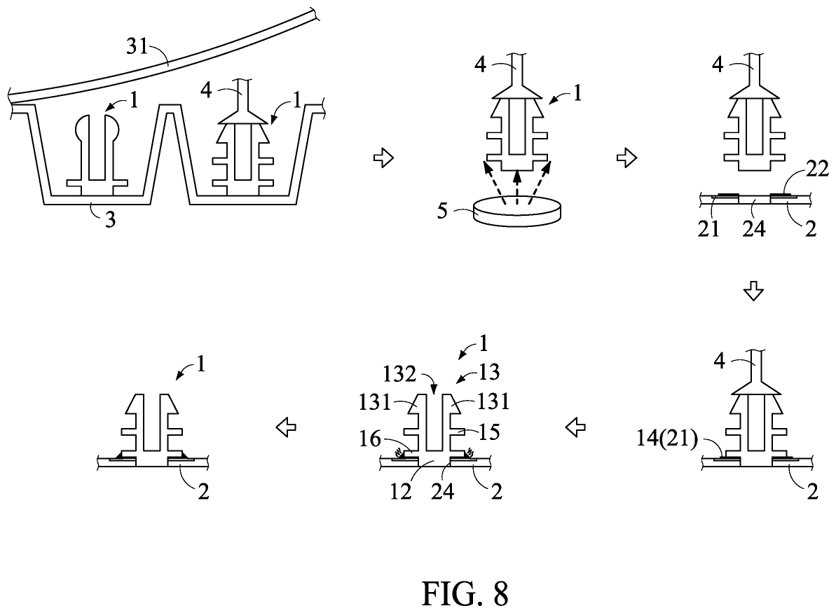

The welding connection element 1 of the present invention is arranged at a carrier 3 (or be provided in advance at a carrier 3), picked up by a tool 4, compared with an assembly position of the object 2 by a comparison device 5, and placed at the assembly position by the tool 4, so as to enable the welding connection element 1 to be assembled to the object 2 (as shown in FIG. 8).

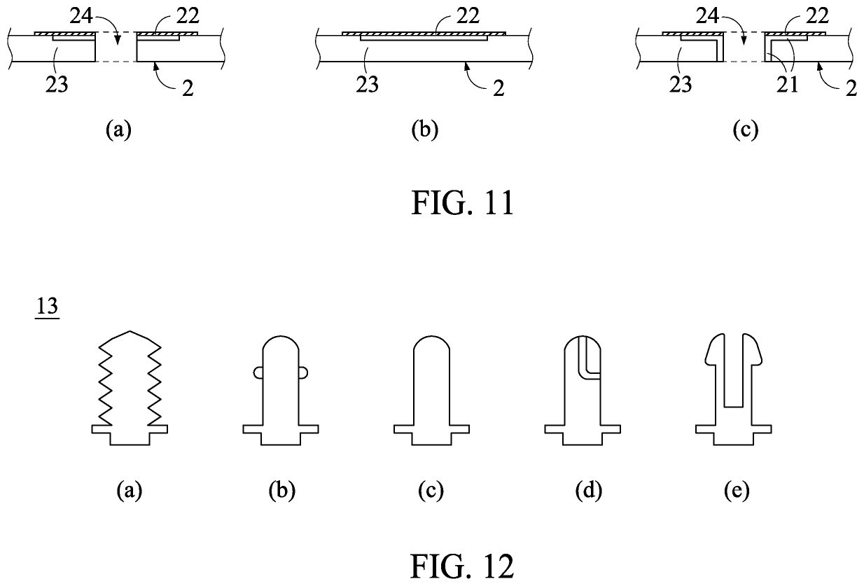

The welding connection element 1 of the present invention has a welding surface 14 configured to be welding connected to a welding surface 21 of the object 2. The welding surface 21 of the object 2 is provided in advance with a solder layer 22 configured to be heated and to welding connect between the welding surfaces 13 and 21 of the welding connection element 1 and the object 2, enabling the welding connection element 1 to be assembled to the object 2. As shown in FIG. 8, the solder layer 22 is disposed on top of the welding surface 21 of the object 2, however a portion of the welding surface 21 of the object 2 is exposed from under the solder layer 22, and the solder layer 22 is welding connected on an outer surface of the body 11 of the welding connection element 1. A non-welding surface 23 of the object 2 is under the welding surface 21 of the object 2. The welding surface 21 of the object 2 is arranged on a planar surface, on a surface, in an insertion portion or on a surface of an insertion surface. Further, the welding connection element 1 is assembled to an assembled portion 24 of the object 2. The assembled portion 24 is an insertion portion (as shown by parts a and b in FIG. 11), a recess, a protrusion, a slot, a hole or a planar surface portion (as shown by part c in FIG. 11). As shown in FIG. 11, the solder layer 22 covers the welding surface 21 of the object 2.

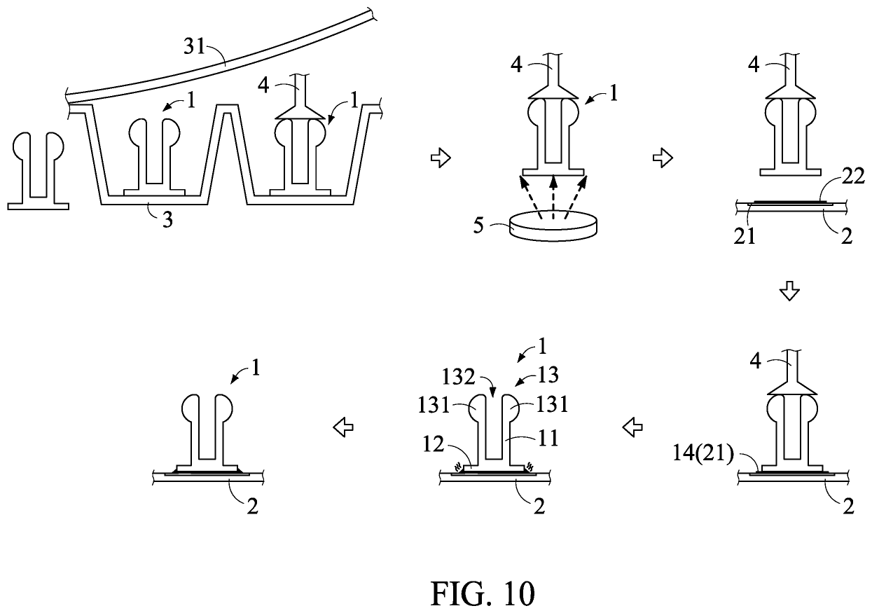

To put to use (as shown in FIG. 8, FIG. 9 and FIG. 10), the welding connection element 11 may be provided in advance in the carrier 3, taken out by the tool 4, compared with the assembly position of the object 2 by the comparison device 5, and placed at the assembly position by the tool. Thus, the welding surface 14 of the welding connection element 1 and the welding surface 21 of the object 21 are heated and welding connected, enabling the welding connection element 1 to be assembled to the object 2. Then, by coordination of the fastening portions 131 and the elastic withdrawal space 132, the another object 6 is fastening connected with the fitting fastening portion 131 or unfastened from the fitting fastening portion 13. Thus, the welding connection element 1 is capable of fastening connecting or unfastening to complete fastening connection or unfastening of at least two objects, achieving the object of repeated quick fastening connection and unfastening.

In one embodiment of the present invention, a support portion 15 (as shown in FIG. 2, FIG. 8 and FIG. 9) is provided below the fitting fastening portion 13 of the body 11. The support portion 15 is configured to fittingly engage the another object 6 that is receivingly fastened. Further, the support portion 15 is configured to define the position for the assembly portion 12 to be assembled to the object 2, and supports the position of the another object 6 that is receivingly fastened in the fitting fastening portion 13. Thus, the welding connection element 1 is enabled to be stably coupled with the another object 6.

In one embodiment of the present invention, the assembly portion 12 includes a shoulder 16 (as shown in FIG. 1, FIG. 2, FIG. 3, FIG. 6 and FIG. 7), which is capable of supporting the assembled portion 24 of the object 2. Thus, the welding connection element 1 is enabled to be stably coupled with the another object 6.

In one embodiment of the present invention, the welding surface 14 of the welding connection element 1 is provided at the assembly portion 12, and is configured to be heated and welding connected to the welding surface 21 of the object 2. Thus, the welding connection element 1 is enabled to be stably coupled with the another object 6.

In one embodiment of the present invention, the fitting fastening portion 13 may a thread body (as shown by part a in FIG. 12), a protruding fastener (as shown by part b in FIG. 12), a column body (as shown by part c in FIG. 12), an inner fastener (as shown by part d in FIG. 12) or an elastic fastener (as shown by part e in FIG. 12). Thus, the present invention is enabled to better meet requirements of actual applications.

Further, the fitting fastening portion 13 is a fastening portion integrally formed with the body 11. Alternatively, the fitting fastening portion 13 is a notch between the fastening portions and is an integrally formed with the body 11, the fitting fastening portion 13 is a fastener assembled at the body 11, or the fitting 13 fastening portion is a sphere assembled at the body 11.

In one embodiment of the present invention, the welding surface 14 of the welding connection element 1, or a welding surface 21 of the object 2 configured for assembly and welding connection, is a copper layer, a tin layer or a nickel layer. Thus, the present invention is enabled to better meet requirements of actual applications.

In one embodiment of the present invention, the carrier 3 includes a cover 31 (as shown in FIG. 8 and FIG. 10). The cover 31 is opened, and the welding connection element 1 is picked up by a tool and placed at the object 2 for welding connection. Thus, the present invention is enabled to better meet requirements of actual applications.

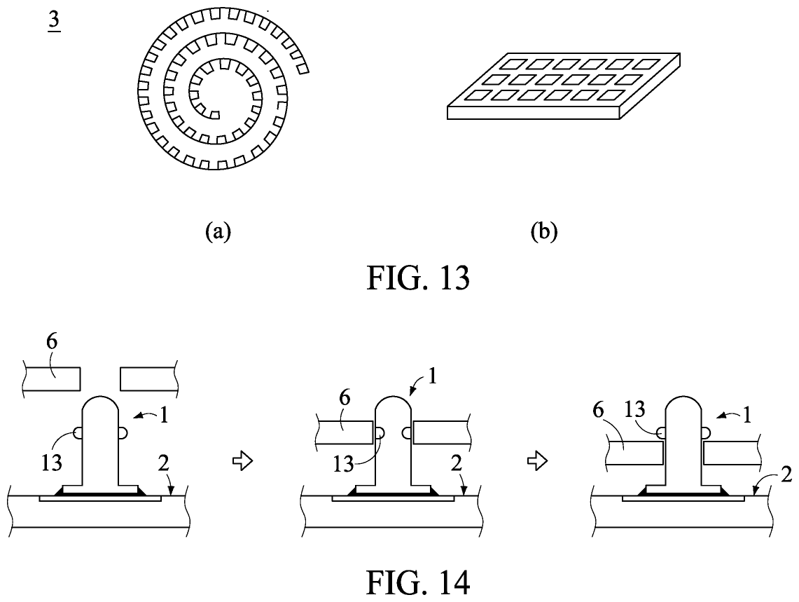

In one embodiment of the present invention, the welding connection element 1 is provided at the carrier 3, which is a feed belt (as shown by part a in FIG. 13) or a feed tray (as shown by part b in FIG. 13). Thus, the present invention is enabled to better meet requirements of actual applications.

In one embodiment of the present invention, the tool 4 is a vacuum suction tool, a fattener, a fixture or a magnetic fool. Thus, the present invention is enabled to better meet requirements of actual applications.

In one embodiment of the present invention, the comparison device 5 is a visual comparison device, an image comparison device, a distance comparison device or a computer comparison device. Thus, the present invention is enabled to better meet requirements of actual applications.

As shown in FIG. 14, the fitting fastening portion 13 of the present invention is a protruding fastener. Once the welding connection element 1 is assembled to the object 2, the another object 6 is fastening connected by the fitting fastening portion 13, or is unfastened by the fitting fastening portion 13. Thus, the welding connection element 1 is enabled to perform fastening connection or unfastening to complete fastening connection or unfastening of at least two objects, achieving the object of repeated quick fastening connection or unfastening.

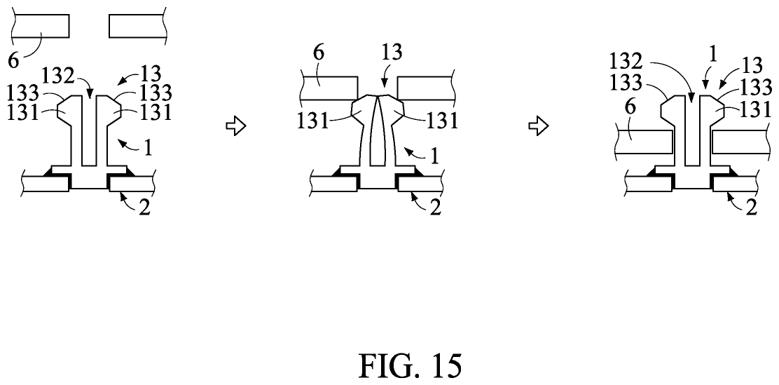

As shown in FIG. 15, a difference of this embodiment from the foregoing embodiment is that, each of the fastening portions 13 has a guiding surface 133, which is configured to enable the elastic withdrawal space 132 to elastically withdraw while guiding the another object 6 to be receivingly fastened in the fitting fastening portion 13, so as to fastening connect or unfasten the another object 6 by the fitting fastening portion 13. Thus, the welding connection element 1 is enabled to perform fastening connection or unfastening to complete fastening connection or unfastening of at least two objects, achieving the object of repeated quick fastening connection or unfastening.

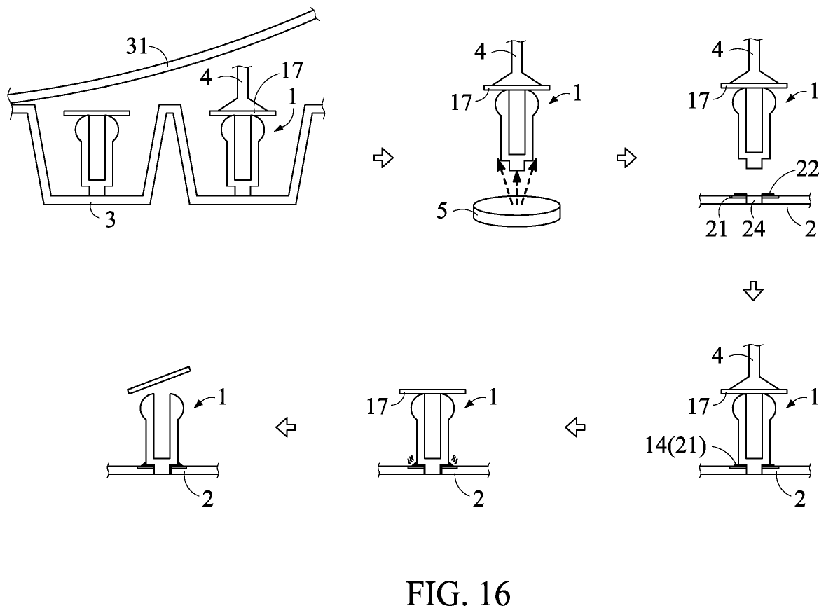

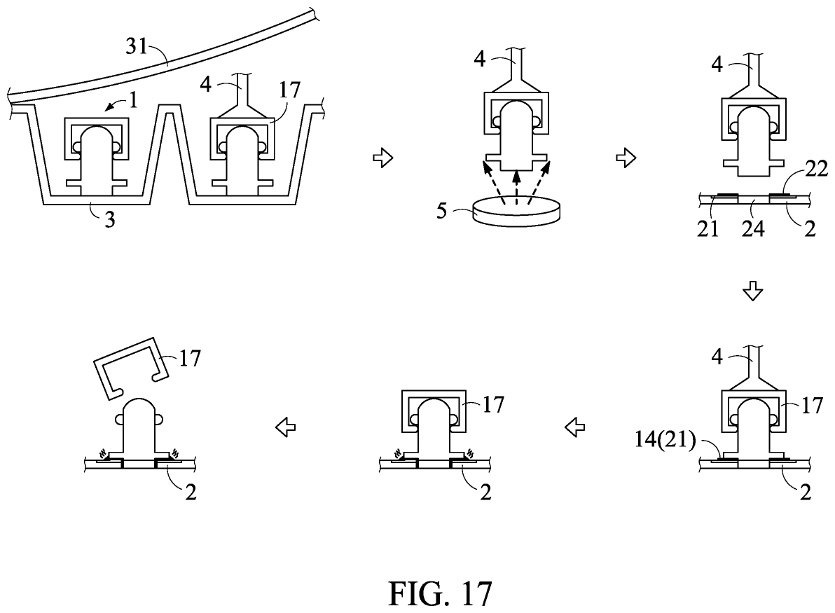

As shown in FIGS. 16 and 17, a difference of this embodiment from the foregoing embodiments is that, the welding connection element 1 is provided with an intermediate body 17. The welding connection element 1 is picked up by the tool 4 via the intermediate body 17, compared with the assembly position of the welding connection element 1 and the object 2 by the comparison device 5, and placed at a welding position by the comparison device 5 so as to be welding connected to the object 2. Thus, the present invention is enabled to better meet requirements of actual applications.

In one embodiment of the present invention, once the welding connection element 1 is picked up by the tool 4 via the intermediate body 17, placed at the assembly position of the object 2 and welding connected, the intermediate body 17 may be removed, so as to fastening connect the another object 6 by the fitting fastening portion 13. Thus, the present invention is enabled to better meet requirements of actual applications.

In one embodiment of the present invention, the intermediate body 17 is a plate (as shown in FIG. 16) or a fastener (as shown in FIG. 17). Thus, the present invention is enabled to better meet requirements of actual applications.

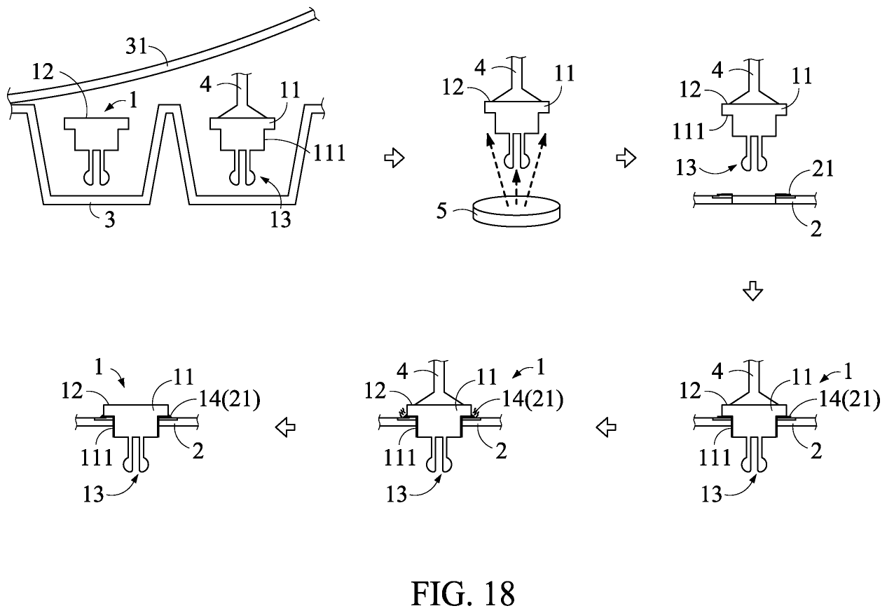

As shown in FIG. 18, a difference of this embodiment from the foregoing embodiments is that, the tool 4 may pick up the welding connection element 1 from the position of the assembly portion 13, the welding connection element 1 is placed at the assembly position of the object 1, and the welding surfaces 14 and 21 of the welding connection element 1 and the object 2 are heated and welding connected, enabling the welding connection element 1 to be assembled to the object 2. Thus, the present invention is enabled to better meet requirements of actual applications.

In one embodiment of the present invention, the assembly portion 12 has a width more than that of the assembled portion 24 of the object 2, and the fitting fastening portion 13 has a width less than that of the assembled portion 24 of the object 2. The fitting fastening portion 13 is first inserted in the assembled portion 24, and is the assembled to the object 2 by the assembly portion 12. Thus, the present invention is enabled to better meet requirements of actual applications.

In one embodiment of the present invention, a limiting portion 111 of the body 11 has a width less than that of the assembled portion 24 of the object 2 and more than that of the fitting fastening portion 13, and is configured to be inserted in the assembled portion 24, so as to limit the space and position corresponding to the assembled portion 24. Thus, the present invention is enabled to better meet requirements of actual applications.

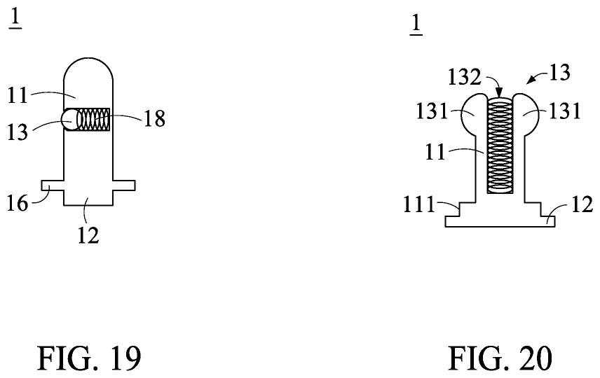

As shown in FIGS. 19 and 20, a difference of this embodiment from the foregoing embodiments is that, the body 11 includes an elastic element 18. The elastic element 18 presses the fitting fastening portion 13 horizontally or vertically, so as to enable another object (not shown) to be fastening connected by the fitting fastening portion 13, or to provide a reciprocal elastic force by the elastic element 18 when unfastening from the fitting fastening portion 13. Thus, the present invention is enabled to better meet requirements of actual applications.

In one embodiment of the present invention, the elastic element 18 may be provided horizontally between the body 11 and the fitting fastening portion 13 (as shown in FIG. 19). Alternatively, the elastic element 18 may be provided vertically between the fastening portions 131 of the fitting fastening portion 13 (for example, provided in the elastic withdrawal space 132, as shown in FIG. 20). Thus, the present invention is enabled to better meet requirements of actual applications.

Further, the fitting fastening portion 13 has an outer diameter more than that of a fastening connected structure of another object, and is configured to be shrunken by horizontally applying interference to being capable of passing through the fastening connected structure, and then restoringly expanded to being fastened to the fastening connected structure, so as to enable the fastening portions 131 to be fastening connected to the another object (as shown in FIG. 19).

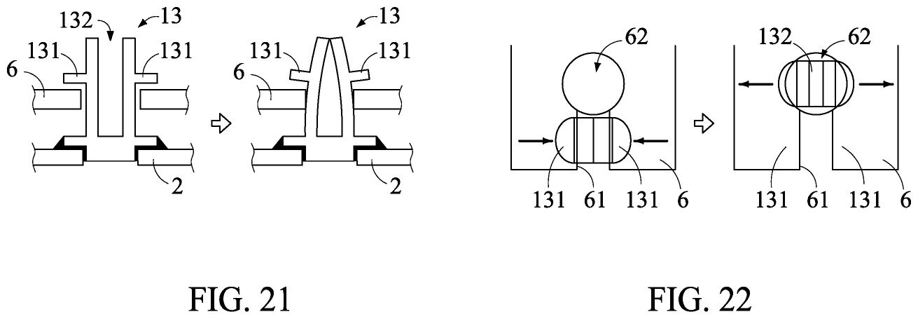

As shown in FIG. 21 and FIG. 22, a difference of this embodiment from the foregoing embodiments is that, the fitting fastening portion 13 has an outer diameter more than that of an opening portion 61 of a fastening connected structure of another object, and is configured to be shrunken by horizontally applying interference to being capable passing through the opening portion 61 of the fastening connected structure, and then restoringly expanded to being fastened to a receivingly fastening portion 62 larger than the opening portion 61 of the fastening connected structure, so as to enable the fitting fastening portion 13 to be fastening connected to the another object 6.

While the invention has been described by way of example and in terms of the embodiments, a person skilled in the art should understood that the embodiments are for illustrating the present invention and are not to be construed as limitations to the scope of the present invention. It should be noted that, equivalent modifications and substitutions made to the embodiments are to be encompassed with the scope of the present invention. Therefore, the protection scope of the present invention is to be accorded with the appended claims.

What is claimed is:

1. A welding connection element, comprising a body, an assembly portion and a welding surface; wherein, the welding surface of the welding connection element is welding connected to a welding surface of an object, a non-welding surface is under the welding surface of the object, the welding surface of the object is provided with a solder layer to welding connect the welding surface of the welding connection element, the welding surface of the object is exposed from the solder layer or the solder layer covers the welding surface of the object.

2. The welding connection element according to claim 1, wherein the assembly portion is configured to be assembled to the object, a fitting fastening portion of the body has an elastic withdrawal space capable of elastically withdrawing two or more fastening portions so as to enable the fastening portions to be receivingly fastened in another object.

3. The welding connection element according to claim 1, wherein the assembly portion is configured to be assembled to the object, and the fitting fastening portion of the body has an elastic withdrawing space configured to enable the fastening portion to be receivingly fastened in another object.

4. The welding connection element according to claim 1, wherein a support portion is provided below a fitting fastening portion of the body, and the support portion is configured to fittingly engage another object that is receivingly fastened.

5. The welding connection element according to claim 1, wherein the assembly portion comprises a shoulder, which is capable of supporting an assembled portion of the body.

6. The welding connection element according to claim 1, being provided at a carrier in advance; wherein, the carrier comprises a cover, and the cover is opened, and the welding connection element is picked up by a tool and placed at the object for welding connection.

7. The welding connection element according to claim 1, wherein the welding surface of the welding connection element, or the welding surface of the object configured for assembly and welding connection, is a copper layer, a tin layer or a nickel layer.

8. The welding connection element according to claim 1, wherein a fitting fastening portion of the body comprises two or more fasteners, an elastic withdrawal space is present between the fasteners, and each of the fasteners has a guiding surface configured to enable the elastic withdrawal space to elastic withdraw while guiding another object to be receivingly fastened.

9. The welding connection element according to claim 1, wherein a fitting fastening portion of the body is a thread body, a protruding fastener, a column body, an inner fastener or an elastic fastener.

10. The welding connection element according to claim 1, comprising an intermediate body; wherein, the welding connection element is picked up by a tool via the intermediate body, compared with an assembly position of the welding connection element and the object by a comparison device, and placed at a welding position so as to be welding connected to the object.

11. The welding connection element according to claim 1, comprising an intermediate body; wherein, the welding connection element is picked up by a tool via the intermediate body, placed at an assembly position of the object and weld connected, and the intermediate body is then removed.

12. The welding connection element according to claim 1, wherein a support portion is provided between a fitting fastening portion of the body and the assembly portion, and the support portion is configured to define a position for the assembly portion to be assembled to the object and supports a position of another object that is receivingly fastened in the fitting fastening portion.

13. The welding connection element according to claim 1, wherein the object is a printed circuit board.

14. The welding connection element according to claim 1, wherein the assembly portion has a width more than that of an assembled portion of the object, a fitting fastening portion of the body has a width less than that of the assembled portion of the object, and the fitting fastening portion is first inserted into the assembled portion and is then assembled to the object by the assembly portion.

15. The welding connection element according to claim 1, wherein a limiting portion of the body has a width less than that of an assembled portion of the object and more than that of a fitting fastening portion of the body, and is configured to be inserted in the assembled portion so as to limit a space and a position corresponding to the assembled portion.

16. The welding connection element according to claim 1, wherein the body comprises an elastic element, which presses a fitting fastening portion of the body vertically or horizontally to provide a reciprocal elastic force.

17. The welding connection element according to claim 1, wherein a fitting fastening portion of the body is a fastener formed integrally with the body, the fitting fastening portion is a notch between fastening portions of the fitting fastening portion and is integrally formed with the body, the fitting fastening portion is a fastener assembled at the body, or a fitting fastener is a sphere assembled at the body.

18. The welding connection element according to claim 1, wherein a fitting fastening portion of the body has an outer diameter more than that of a fastening connected structure of another object to be fastened to, and is configured to be shrunken by applying interference from bottom-up or from top-down to being capable of passing through the fastening connected structure, and then restoringly expanded to being fastening at the fastening connected structure so as to be fastening connected to another object.

19. The welding connection element according to claim 1, wherein a fitting fastening portion of the body has an outer diameter more than that of a fastening connected structure of another object to be fastened to, and is configured to be shrunken by horizontally applying interference to being capable of passing through the fastening connected structure, and then restoringly expanded to being fastened at the fastening connected structure so as to be fastening connected to another object.

20. The welding connection element according to claim 1, wherein a fitting fastening portion of the body has an outer diameter more than that of an opening portion of a fastening connected structure of another object to be fastened to, and is configured to be shrunken by horizontally applying interference to being capable of passing through the opening portion of the fastening connected structure, and the restoringly expanded to being fastened at a receivingly fastening portion larger than the opening portion of the fastening connected structure, so as to be fastening connected to another object.

21. A welding connection element, comprising a body, an assembly portion and a welding surface; wherein, the welding surface of the welding connection element is welding connected to a welding surface of an object, a non-welding surface is under the welding surface of the object, the welding surface of the object is provided with a solder layer, the solder layer is welding connected between the welding surface of the welding connection element and the welding surface of the object, the solder layer is welding connected on an outer surface of the welding connection element.
